(19) United States
(12) Patent Application Publication
(10) Pub. No.: US 2011/0183237 A1
(43) Pub. Date: Jul. 28, 2011

(54) ANION CONDUCTING ELECTROLYTE RESIN AND A METHOD FOR PRODUCING THE SAME

(75) Inventors: Zenpachi Ogumi, Kyoto-fu (JP); Koji Nishio, Kyoto-fu (JP); Haruyuki Nakanishi, Shizuoka-ken (JP); Hidekazu Akikawa, Shizuoka-ken (JP)

(73) Assignee: TOYOTA JIDOSHA KABUSHIKI KAISHA, Toyota-shi, Aichi-ken (JP)

(21) Appl. No.: 13/002,757

(22) PCT Filed: Jul. 15, 2009
(86) PCT No.: PCT/JP2009/062789

§ 371 Date: Mar. 21, 2011

(30) Foreign Application Priority Data
Jul. 15, 2008 (JP) 2008-183686

(51) Int. Cl. H01M 8/10; H01M 8/00

(52) U.S. Cl. 429/494; 429/535

(57) ABSTRACT

The present invention is to provide an anion conducting electrolyte resin with high anion conducting ability and excellent workability, and a method for producing the same.

An anion conducting electrolyte resin comprising a perfluorocarbon electrolyte polymer in which the whole or part of the polymer has a sulfonate group (—SO₃⁻), and a modifier molecule comprising two or more positively-charged groups, wherein an ionic interaction occurs between the sulfonate group of the perfluorocarbon electrolyte polymer and one or more of the positively-charged groups of the modifier molecule to modify the perfluorocarbon electrolyte polymer by the modifier molecules, and wherein an ionic interaction occurs between the rest of the positively-charged groups of the modifier molecule and an anion.

### TECHNICAL FIELD

The present invention relates to an anion conducting electrolyte resin with high anion conducting ability and excellent workability, and a method for producing the same.

### BACKGROUND ART

A fuel cell converts chemical energy directly to electrical energy by supplying fuel and an oxidant to two electrically-connected electrodes and thus causing electrochemically oxidization of the fuel. Unlike thermal power generation, fuel cells are not subject to Carnot's cycle, so that they show high energy conversion efficiency. A fuel cell generally consists of stacked cells, each of which has a basic structure that is a membrane electrode assembly in which an electrolyte membrane is sandwiched between a pair of electrodes. Especially, solid polymer electrolyte fuel cells, which comprise a solid polymer electrolyte layer as the electrolyte membrane, have attracted attention as especially a portable, mobile power source due to their advantages such that they can be downsized easily, work at low temperature, etc.

In alkali fuel cells, the reaction described by the formula (1) proceeds at the anode (fuel electrode) when using hydrogen as fuel:

H₂+2OH⁻→2H₂O+2e⁻ (1)

The electron produced by the formula (1) passes through an external circuit, which acts as an external load, and then reaches the cathode (oxidant electrode). Then, the water produced by the formula (1) passes mainly through a gas diffusion layer to be emitted to the outside, or it is transported inside a solid polymer electrolyte membrane from the anode to the cathode and then used for the reaction described by the below-mentioned formula (2) at the cathode.

When oxygen is used as the oxidant, the reaction described by the formula (2) proceeds at the cathode:

(½)O₂+H₂O+2e⁻→2OH⁻ (2)

The hydroxide ion produced by the formula (2) is, in a hydrated state, transported by electro-osmosis inside a solid polymer electrolyte membrane from the cathode side to the anode side. As just described, fuel cells produce no emissions except water and they are a clean power generation device, therefore.

As the anion conducting electrolyte resin conventionally used for alkali fuel cells, a copolymer or a polymer mixture is generally known, which are obtained by combining hydrocarbon monomers and modified by polymeric reaction. However, such a resin is known to deteriorate in the presence of a strong base. Also, a hydrocarbon polymer has no sufficient durability, so that it is not adequate as, for example, an electrolyte resin that is mixed with a catalyst layer of a fuel cell for use.

To overcome the problems of the anion conducting electrolyte resin, technological development has been attempted in connection with an anion conducting electrolyte resin comprising a fluorine-containing polymer.

Patent literature 1 discloses a technique that relates to an anion-exchange polymer solution comprising a solution obtained by dissolving, in a solvent containing a fluorine-containing alcohol, a fluorine-containing anion-exchange polymer having a main chain comprising a perfluorocarbon polymer and having quaternized nitrogen atoms at the ends of side chains.

Patent literature 2 discloses a membrane-type anion exchanger which contains a quaternary ammonium group(s) and of which main chain is a perfluorocarbon polymer.

### Citation List

Patent Literature 1: Japanese Patent Application Laid-Open No. 2001-81261

Patent Literature 2: Japanese Patent Application Publication No. H3-12568

### SUMMARY OF INVENTION

### Technical Problem

As described by the formula (2), at the cathode side of an alkali fuel cell, a gas (oxygen or O₂), a liquid (water or H₂O) and a solid that participates in the conduction of electrons (e⁻) have to be present and reacted at the same time in a nano-level catalyst reaction phase. At the cathode side, therefore, an anion conducting electrolyte resin is needed to form an excellent triple phase boundary, which has excellent oxygen and water permeability, which is able to conduct a hydroxide ion to be produced, and which has workability for mixing appropriately with an electrode catalyst layer.

Techniques are disclosed in Patent Literatures 1 and 2, each of the techniques relates to an anion conducting electrolyte resin in which a fluorine-containing polymer and a group containing a quaternary ammonium group are connected by a covalent bond. However, none of such substances has excellent properties as a solution or dispersion liquid that is appropriate to be mixed with an electrode catalyst layer or to be processed.

Moreover, the technique disclosed in Patent Literature 2 is a membrane-type anion exchanger technique, and in Patent Literature 2, there is no description relating to workability, which is a property that the anion conducting electrolyte resin contained in a catalyst layer is required to have, for example.

An object of the present invention is to provide an anion conducting electrolyte resin with high anion conducting ability and excellent workability, which is especially able to form an ion conducting phase in an electrode catalyst layer easily. Another object of the present invention is to provide a method for producing the anion conducting electrolyte resin.

### Solution to Problem

The anion conducting electrolyte resin of the present invention is an anion conducting electrolyte resin comprising a perfluorocarbon electrolyte polymer in which the whole or part of the polymer has a sulfonate group (—SO₃⁻), and a modifier molecule comprising two or more positively-charged groups, wherein an ionic interaction occurs between the sulfonate group of the perfluorocarbon electrolyte polymer and one or more of the positively-charged groups of the modifier molecule to modify the perfluorocarbon electrolyte polymer by the modifier molecules, and wherein an ionic interaction occurs between the rest of the positively-charged groups of the modifier molecule and an anion.

In the anion conducting electrolyte resin of such a structure, an ionic interaction occurs between the sulfonate group of the perfluorocarbon electrolyte polymer and one or more of the positively-charged groups of the modifier molecule to modify the perfluorocarbon electrolyte polymer by the modifier molecules; therefore, it is able to connect the perfluorocarbon electrolyte polymer with an anion that should be transported by the modifier molecule. In addition, the structure of the anion conducting electrolyte resin of the present invention is more flexible than the structure of the prior-art anion conducting electrolyte resins in which a fluorine-containing polymer and a quaternary ammonium group are connected by a covalent bond; therefore, the anion conducting electrolyte resin of the present invention is able to transport an anion over a long distance and thus has high anion conducting ability. Also, the anion conducting electrolyte resin of the present invention has the perfluorocarbon electrolyte polymer as a part of its skeleton; therefore, the resin is dense and has high workability and durability.

Preferably in the anion conducting electrolyte resin of the present invention, the modifier molecule is a cation in which two or more ammonium groups are connected to a group comprising two or more carbon atoms, wherein an ionic bond is formed between the sulfonate group of the perfluorocarbon electrolyte polymer and one or more of the ammonium groups of the cation to connect the perfluorocarbon electrolyte polymer with the cations, and wherein an ionic bond is formed between the rest of the ammonium groups of the cation and an anion.

In the anion conducting electrolyte resin of such a structure, an ionic bond is formed between the sulfonate group of the perfluorocarbon electrolyte polymer and one or more of the ammonium groups of the cation to connect the perfluorocarbon electrolyte polymer with the cations; therefore, it is able to connect the perfluorocarbon electrolyte polymer with an anion that should be transported by the cation. In addition, the structure of the anion conducting electrolyte resin of the present invention is more flexible than the structure of the prior-art anion conducting electrolyte resins in which a fluorine-containing polymer and a quaternary ammonium group are connected by a covalent bond; therefore, the anion conducting electrolyte resin of the present invention is able to transport an anion over a long distance and thus has high anion conducting ability. In the anion conducting electrolyte resin of the present invention, the cation has the group comprising two or more carbon atoms; therefore, the cation is able to form a longer chain molecular structure than cations which do not have that group, so that it is able to connect the perfluorocarbon electrolyte polymer with an anion that should be transported over a wider range. Also, the anion conducting electrolyte resin of the present invention has the perfluorocarbon electrolyte polymer as a part of its skeleton; therefore, the resin is dense and has high workability and durability.

An embodiment of the anion conducting electrolyte resin of the present invention is such that the cation has a structure in which two or more groups are connected to at least one ammonium group, each of the groups being the group comprising two or more carbon atoms, to which one or more ammonium groups are connected.

In the anion conducting electrolyte resin of such a structure, the cation has a structure in which two or more groups are connected to at least one ammonium group (hereinafter may be referred to as the first ammonium group), each of the groups being the group comprising two or more carbon atoms, to which one or more ammonium groups (hereinafter may be referred to as the second ammonium group(s)) are connected. Thus, the cation has a kind of resinous, branched-chain structure when it is connected to the sulfonate group of the perfluorocarbon electrolyte polymer via the first ammonium group; therefore, compared to a cation that has a kind of linear-chain structure when connected to the sulfonate group, the cation of the present invention has a larger number of ammonium groups (the second ammonium groups) each of which is likely to form an anion conducting path, so that it is able to increase the anion conductivity of the anion conducting electrolyte resin of the present invention.

An embodiment of the anion conducting electrolyte resin of the present invention is such that the ammonium groups are a primary or secondary ammonium group each.

Preferably in the anion conducting electrolyte resin of the present invention, the group comprising two or more carbon atoms of the cation is a hydrocarbon group.

In the anion conducting electrolyte resin of such a structure, the cation can be designed into various types of cations by changing the carbon chain length of the hydrocarbon group and the bonding configuration of the carbon chain of the hydrocarbon group; therefore, the type of the cation can be selected from various possible types, depending on the intended use.

Preferably in the anion conducting electrolyte resin of the present invention, the hydrocarbon group has 2 to 4 carbon atoms.

The anion conducting electrolyte resin of such a structure has high anion conducting ability because the cation has the hydrocarbon group which has a length that is appropriate for anion giving and receiving.

The anion conducting electrolyte resin of the present invention preferably has an ion exchange capacity of 0.5 meq/g or more.

The anion conducting electrolyte resin of such a structure has sufficient anion transporting ability.

The anion conducting electrolyte resin of the present invention is preferably used for alkali fuel cells.

The anion conducting electrolyte resin of the present invention is preferably used as an electrolyte resin for the cathode electrode catalyst layer of an alkali fuel cell.

The method for producing an anion conducting electrolyte resin of the present invention is a method for producing an anion conducting electrolyte resin, wherein a perfluorocarbon sulfonic acid polymer is modified by an electron-pair donating molecule comprising two or more electron-pair donating groups having an unshared electron pair each.

Such a production method is able to produce the anion conducting electrolyte resin of the present invention by adding the electron-pair donating molecules to the perfluorocarbon sulfonic acid polymer.

In the method for producing an anion conducting electrolyte resin of the present invention, preferably, the electron-pair donating molecule is an amine molecule in which two or more amino groups are connected to a group comprising two or more carbon atoms.

The amine molecule shows excellent unshared electron pair-donating ability; therefore, such a production method is able to produce the anion conducting electrolyte resin of the present invention just by adding the amine molecules to the perfluorocarbon sulfonic acid polymer.

An embodiment of the method for producing an anion conducting electrolyte resin of the present invention is such that the amino groups are a primary or secondary amino group each.

In the method for producing an anion conducting electrolyte resin of the present invention, preferably, the group comprising two or more carbon atoms of the amine molecule is a hydrocarbon group.

In such a production method, the amine molecule can be designed into various types of amine molecules by changing the carbon chain length of the hydrocarbon group and the bonding configuration of the carbon chain of the hydrocarbon group; therefore, the type of the amine molecule can be selected from various possible types, depending on the intended use.

In the method for producing an anion conducting electrolyte resin of the present invention, preferably, the hydrocarbon group has 2 to 4 carbon atoms.

Such a production method is able to produce an anion conducting electrolyte resin in which the cation has the hydrocarbon group which has a length that is appropriate for anion giving and receiving.

### ADVANTAGEOUS EFFECTS OF INVENTION

In the anion conducting electrolyte resin of the present invention, an ionic interaction occurs between the sulfonate group of the perfluorocarbon electrolyte polymer and one or more of the positively-charged groups of the modifier molecule to modify the perfluorocarbon electrolyte polymer by the modifier molecules; therefore, it is able to connect the perfluorocarbon electrolyte polymer with an anion that should be transported by the modifier molecule. In addition, the structure of the anion conducting electrolyte resin of the present invention is more flexible than the structure of the prior-art anion conducting electrolyte resins in which a fluorine-containing polymer and a quaternary ammonium group are connected by a covalent bond; therefore, the anion conducting electrolyte resin of the present invention is able to transport an anion over a long distance and thus has high anion conducting ability. Also, the anion conducting electrolyte resin of the present invention has the perfluorocarbon electrolyte polymer as a part of its skeleton; therefore, the resin is dense and has high workability and durability. The method for producing an anion conducting electrolyte resin of the present invention is able to produce the anion conducting electrolyte resin of the present invention by adding the electron-pair donating molecules to the perfluorocarbon sulfonic acid polymer.

### BRIEF DESCRIPTION OF DRAWINGS

FIG. 1 is a view showing that a typical example of the anion conducting electrolyte resin of the present invention transports an anion.

FIG. 2 is a view showing a first preferred embodiment of the typical example.

FIG. 3 is a view showing a second preferred embodiment of the typical example.

FIG. 4 is a view showing a different embodiment of the typical example.

FIG. 5 is a view showing that a variation of the anion conducting electrolyte resin of the present invention transports an anion.

FIG. 6 is a view showing that a second variation of the anion conducting electrolyte resin of the present invention transports an anion.

FIG. 7 is a view showing that a third variation of the anion conducting electrolyte resin of the present invention transports an anion.

FIG. 8 is a schematic view showing a two-compartment cell that was used for oxygen reduction property measurement.

FIG. 9 shows the result of measuring oxygen reduction reaction by a quasi-steady-state polarization method.

FIG. 10 shows potential curves of oxygen reduction reaction measured by a potential sweep method.

FIG. 11 is a schematic view of a two-compartment cell that was used for anionic transport number measurement.

FIG. 12 shows an experimental result data showing the relationship between membrane potential Eₘ and ln(a₂) of an ethylenediamine-modified perfluorocarbon sulfonic acid polymer electrolyte resin produced in Example 2, both of Eₘ and ln(a₂) being obtained by means of the two-component cell.

FIG. 13 shows an experimental result data showing the relationship between membrane potential Eₘ and ln(a₂) of a diethylenetriamine-modified perfluorocarbon sulfonic acid polymer electrolyte resin produced in Example 4, both of Eₘ and ln(a₂) being obtained by means of the two-component cell.

### DESCRIPTION OF EMBODIMENTS

The anion conducting electrolyte resin of the present invention is an anion conducting electrolyte resin comprising a perfluorocarbon electrolyte polymer in which the whole or part of the polymer has a sulfonate group (—SO₃⁻), and a modifier molecule comprising two or more positively-charged groups, wherein an ionic interaction occurs between the sulfonate group of the perfluorocarbon electrolyte polymer and one or more of the positively-charged groups of the modifier molecule to modify the perfluorocarbon electrolyte polymer by the modifier molecules, and wherein an ionic interaction occurs between the rest of the positively-charged groups of the modifier molecule and an anion.

The perfluorocarbon electrolyte polymer is a polymer which has a main chain comprising a repeating unit generally represented by (—CF₂—) and which has a functional group such as a sulfonic acid group (—SO₃H). Specific examples thereof include perfluorocarbon sulfonic acid polymers such as Nafion (trade name, available from DuPont), Flemion (trade name, available from Asahi Glass Co., Ltd.) and Aciplex (trade name, available from Asahi Kasei Corporation). Conversion between the sulfonic acid group and the sulfonate group (—SO₃⁻) could take place in the polymer, so that it is not necessary to distinguish them in the polymer.

The modifier molecule is a molecule which functions to connect the perfluorocarbon electrolyte polymer with an anion that should be transported. More specifically, the modifier molecule comprises two or more positively-charged groups, and an ionic interaction occurs between one or more of the positively-charged groups and the sulfonate group of the perfluorocarbon electrolyte polymer to modify the perfluorocarbon electrolyte polymer by the modifier molecules, while an ionic interaction occurs between the rest of the positively-charged groups of the modifier molecule and an anion; therefore, the modifier molecule functions to connect the perfluorocarbon electrolyte polymer with an anion that should be transported.

Examples of the positively-charged groups include cationized electron-pair donating groups having an unshared electron pair each, which were each cationized by mainly receiving a proton.

Preferably, the modifier molecule comprises the positively-charged groups only. It can also contain an electrically neutral group that does not participate in anion conduction.

The modifier molecule can comprise two or more kinds of positively-charged groups and two or more kinds of electrically neutral groups. The configuration and bonding configuration of the positively-charged groups and those of the electrically neutral groups can be any of a linear-chain configuration, a ring configuration and a branched-chain configuration. The anion conducting electrolyte resin of the present invention can contain various types of modifier molecules.

Specific examples of the positively-charged groups include ammonium groups, imidazolium groups, pyridinium groups and phosphonium groups.

Modifying the perfluorocarbon electrolyte polymer by the modifier molecules refers to a state for example in which an ionic bond is formed between the sulfonate group of the perfluorocarbon electrolyte polymer and one of the positively-charged groups of the modifier molecule on a one-to-one basis, so that the perfluorocarbon electrolyte polymer is surface-modified by the modifier molecules. Besides, there may be mentioned a state in which an ionic interaction occurs between one or more of the sulfonate groups and one or more of the modifier molecules, so that the perfluorocarbon electrolyte polymer is surface-modified by the modifier molecules.

A great feature of the anion conducting electrolyte resin of the present invention is such that an ionic interaction occurs between the sulfonate group of the perfluorocarbon electrolyte polymer and one or more of the positively-charged groups of the modifier molecule to modify the perfluorocarbon electrolyte polymer by the modifier molecules.

The anion conducting electrolyte resin of the present invention can be provided with anion conductivity after the perfluorocarbon electrolyte polymer is mixed with an electrode catalyst, so that it is able to design an anion conducting path by the interaction between the side chains of the perfluorocarbon electrolyte polymer (base material), regardless of the configuration of the perfluorocarbon electrolyte polymer. Therefore, it is easy to design an anion conducting path more effectively than the prior-art.

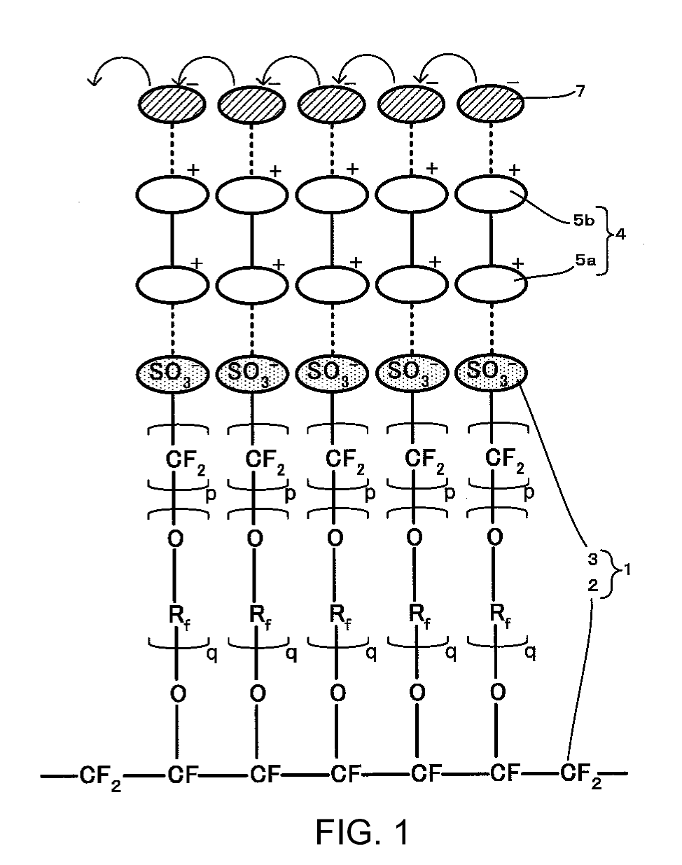

FIG. 1 is a view showing that a typical example of the anion conducting electrolyte resin of the present invention transports an anion. In this figure, a solid straight line represents a covalent bond or a group such as a hydrocarbon group, and a dotted straight line represents an ionic bond.

A perfluorocarbon electrolyte polymer 1 comprises a perfluorocarbon skeleton 2 and a sulfonate group 3. The perfluorocarbon electrolyte polymer 1 has a main chain and a side chain, and the sulfonate group 3 is mainly positioned at the terminal end of the side chain. In the figure, R_{f} in the side chain of the polymer 1 refers to a fluorocarbon group, while each of p and q refers to the polymerization degree of a repeating unit shown in parentheses. R_{f}, p and q are not particularly limited. However, for example, when Nafion is selected as the polymer 1, R_{f} is a fluorocarbon group described by: [the main chain side]-CF₂—CF(CF₃)-[the terminal end side], wherein p=2 and The structure of the perfluorocarbon electrolyte polymer 1 shown in FIG. 1 is an example, and the perfluorocarbon electrolyte polymer used in the present invention is not limited to this structure.

An ionic bond is formed between the sulfonate group 3 which is positioned at the terminal end of the polymer 1 and a positively-charged group 5a which is one of positively-charged groups 5 of a modifier molecule 4, on a one-to-one basis. Furthermore, an ionic bond is formed between the other positively-charged group 5b of the modifier molecule 4 and an anion 7 to transport the anion 7. The positively-charged groups 5a and 5b of the modifier molecule 4 can be directly connected by a covalent bond or can be indirectly connected by a group such as a hydrocarbon group. In the figure, “+” at the upper right side of the positively-charged group 5 means that the charge of the positively-charged group 5 is a monovalent positive charge, while “−” at the upper right side of the anion 7 means that the charge of the molecule 7 is a monovalent negative charge. A curved arrow line above the anion 7 represents an anion conducting path through which the anion 7 is given and received between the positively-charged groups 5b of the modifier molecules 4 to transport the anion 7 therebetween.

In the figure, the modifier molecule 4 is one that has the structure of “positively-charged group 5a-a covalent bond or group-positively-charged group 5b.” However, as described above, the constituents and structure of the modifier molecule is not limited thereto.

Preferably in the anion conducting electrolyte resin of the present invention, the modifier molecule is a cation in which two or more ammonium groups are connected to a group comprising two or more carbon atoms, wherein an ionic bond is formed between the sulfonate group of the perfluorocarbon electrolyte polymer and one or more of the ammonium groups of the cation to connect the perfluorocarbon electrolyte polymer with the cations, and wherein an ionic bond is formed between the rest of the ammonium groups of the cation and an anion.

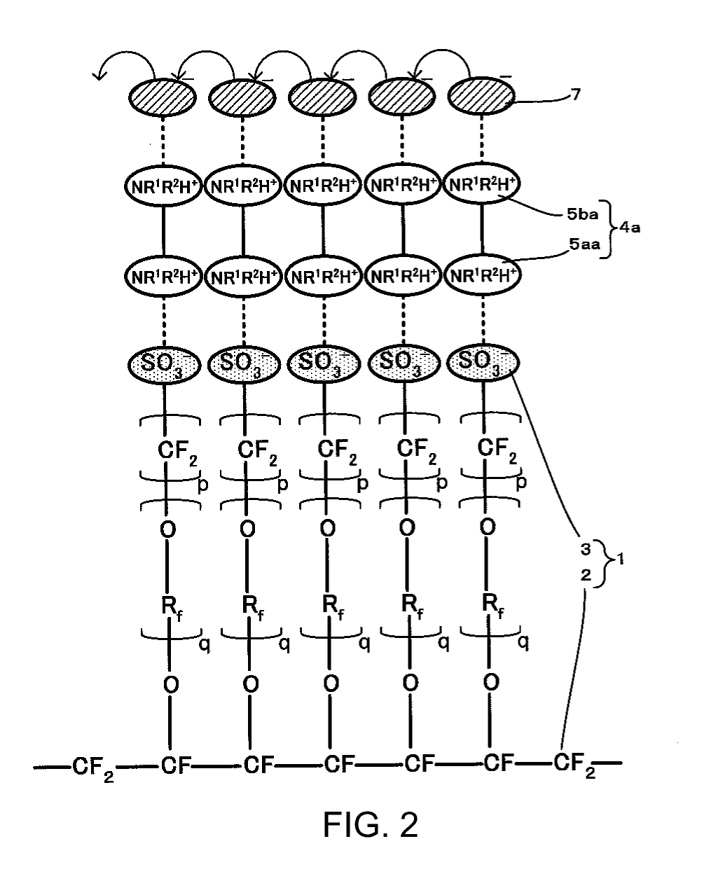

FIG. 2 is a view showing a first preferred embodiment of the above-mentioned typical example. In this figure, an ionic bond is formed between the sulfonate group 3 of the perfluorocarbon electrolyte polymer 1 and an ammonium group 5aa which is one of ammonium groups of a cation 4a, on a one-to-one basis. Furthermore, an ionic bond is formed between the other ammonium group 5ba of the cation 4a and the anion 7 to transport the anion 7.

In FIG. 2, R¹ and R² of the ammonium groups 5aa and 5ba are each a hydrogen or an alkyl group. The ammonium groups 5aa and 5ba of the cation 4a are indirectly connected by a group comprising two or more carbon atoms.

A second preferred embodiment of the above-mentioned typical example is such that the cation has a structure in which two or more groups are connected to at least one ammonium group (hereinafter may be referred to as the first ammonium group), each of the groups being the group comprising two or more carbon atoms, to which one or more ammonium groups (hereinafter may be referred to as the second ammonium group(s)) are connected.

The first ammonium group is not particularly limited. Specific examples thereof include a secondary ammonium group and a tertiary ammonium group.

When a secondary ammonium group is employed as the first ammonium group, it is able to employ a cation that has a structure in which two or more groups are connected to the secondary ammonium group, each of the groups being the group comprising two or more carbon atoms, to which one or more ammonium groups are connected.

When a tertiary ammonium group is employed as the first ammonium group, it is able to employ a cation that has a structure in which three or more groups are connected to the tertiary ammonium group, each of the groups being the group comprising two or more carbon atoms, to which one or more ammonium groups are connected.

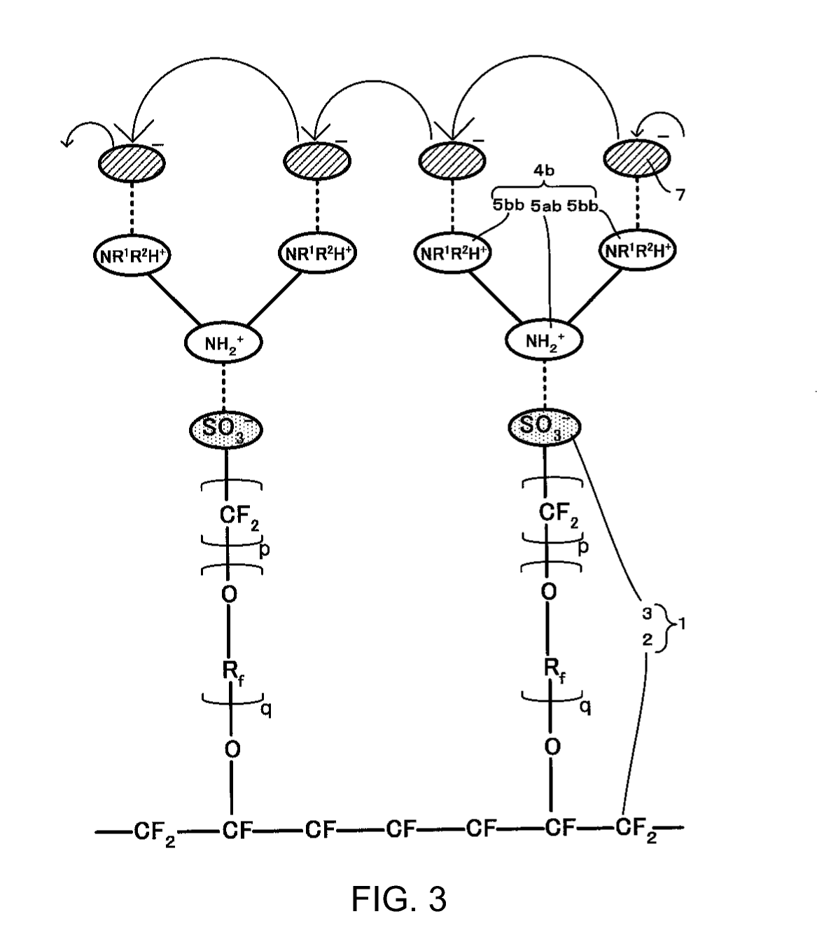

FIG. 3 is a view showing a second preferred embodiment of the above-mentioned typical example. FIG. 3 shows a case in which a secondary ammonium group was employed as the first ammonium group. More specifically, the structure of a cation 4b is “ammonium group 5bb-a group comprising two or more carbon atoms-secondary ammonium group 5ab-a group comprising two or more carbon atoms-ammonium group 5bb” and this is different from FIG. 2. Moreover, the secondary ammonium group 5ab is connected to the sulfonate group of the perfluorocarbon electrolyte polymer.

In this second preferred embodiment, the cation has a structure in which two or more groups are connected to the first ammonium group, each of the groups being the group comprising two or more carbon atoms, to which one or more ammonium groups (the second ammonium group(s)) are connected. Thus, the cation has a kind of resinous, branched-chain structure when it is connected to the sulfonate group of the perfluorocarbon electrolyte polymer via the first ammonium group; therefore, compared to a cation that has a kind of linear-chain structure when connected to the sulfonate group, the cation of the present invention has a larger number of ammonium groups (the second ammonium groups) each of which is likely to form an anion conducting path, so that it is able to increase the anion conductivity of the anion conducting electrolyte resin of the present invention.

In FIG. 3, R¹ and R² of the ammonium group 5bb are each a hydrogen or an alkyl group. The ammonium groups 5ab and 5bb of the cation 4b are indirectly connected by a group comprising two or more carbon atoms.

As described above, in the case of using the cation which has a structure in which two or more groups are connected to at least one ammonium group, each of the groups being the group comprising two or more carbon atoms, to which one or more ammonium groups are connected (hereinafter, such a cation may be referred to as a cation which has a branched structure when connected), all of the cations do not necessarily have the resinous, branched-chain structure as shown in FIG. 3 to connect with the sulfonate group of the perfluorocarbon electrolyte polymer. That is, in FIG. 3, when the ammonium group 5bb is a primary ammonium group, the ammonium group 5bb is connected to the sulfonate group 3 instead of the ammonium group 5ab and the cation could have a linear structure, therefore. However, when the cation which has a branched structure when connected, has a branched-chain structure to connect the sulfonate group 3, it is more likely to disperse charge and is more stable than the case of having a linear structure to connect the sulfonate group. Accordingly, the secondary ammonium group is able to connect with the sulfonate group more efficiently than the primary ammonium group. Therefore, when the cation which has a branched structure when connected, is used, it is more possible that the cation has a resinous, branched-chain structure to connect with the sulfonate group of the perfluorocarbon electrolyte polymer, than that the cation has a linear-chain structure to connect with the sulfonate group.

This is also clear from the results of the below-mentioned Examples. In particular, a diethylenetriamine-modified, perfluorocarbon sulfonic acid polymer electrolyte resin produced in Example 4 showed a very high anionic transport number (t_) of 0.891. This result suggests that in the case of using an amine that is able to produce a cation which has a branched structure when connected (e.g., diethylenetriamine), the cation had a resinous, branched-chain structure to connect with the sulfonate group of the perfluorocarbon electrolyte polymer, so that the cation was able to form a larger number of anion conducting paths than the case of having a linear-chain, connecting structure.

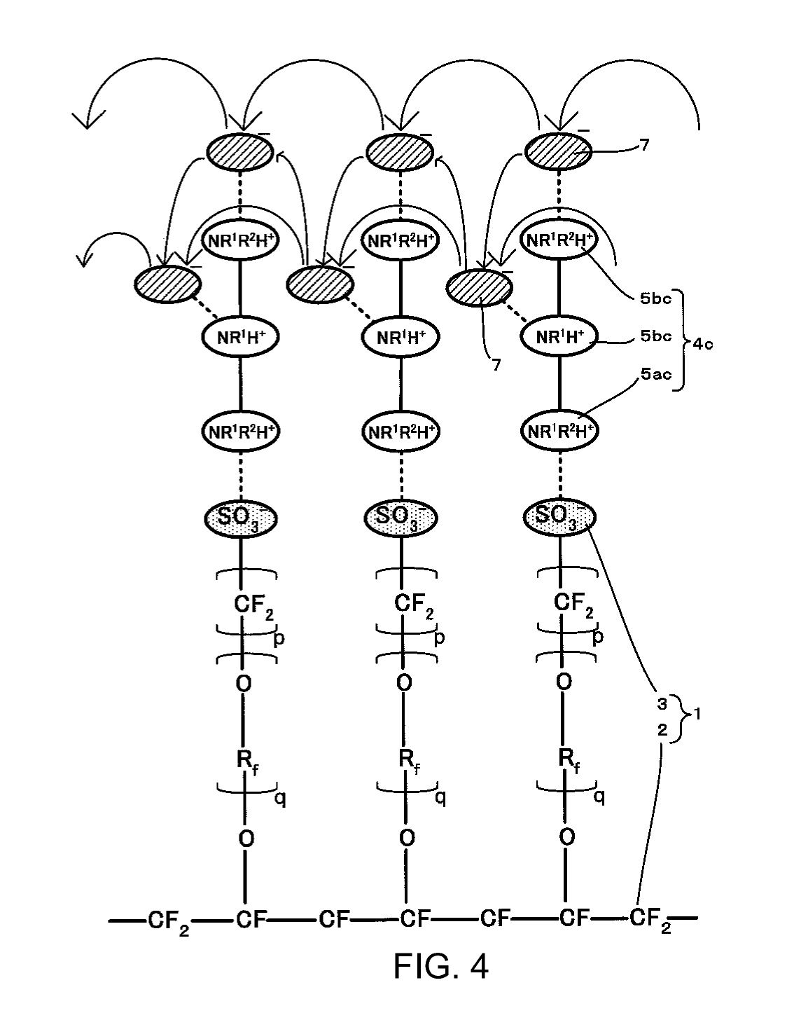

FIG. 4 is a view showing a different embodiment of the above-mentioned typical example. In particular, the structure of a cation 4c is “ammonium group 5ac-a group comprising two or more carbon atoms-ammonium group 5bc-a group comprising two or more carbon atoms-ammonium group 5bc” and this is different from FIG. 2. As a result, a larger number of anion conducting paths are formed than the anion conducting electrolyte resin shown in FIG. 2.

In FIG. 4, R¹ and R² of the ammonium groups 5ac and 5bc are each a hydrogen or an alkyl group. The ammonium groups 5ac and 5bc of the cation 4c are indirectly connected by a group comprising two or more carbon atoms.

An embodiment of the anion conducting electrolyte resin of the present invention can be such that the ammonium groups are a primary or secondary ammonium group each.

Preferably, the group comprising two or more carbon atoms of the cation is a hydrocarbon group. This is because the cation can be designed into various types of cations by changing the carbon chain length of the hydrocarbon group and the bonding configuration of the carbon chain of the hydrocarbon group; therefore, the type of the cation can be selected from various possible types, depending on the intended use.

Preferably, the hydrocarbon group has 2 to 4 carbon atoms. This is because the cation has the hydrocarbon group which has a length that is appropriate for anion giving and receiving, so that the anion conducting electrolyte resin has high anion conducting ability.

In the anion conducting electrolyte resin having the structure of the typical example, an ionic bond is formed between the sulfonate group of the perfluorocarbon electrolyte polymer and one or more of the ammonium groups of the cation to connect the perfluorocarbon electrolyte polymer with the cations; therefore, it is able to connect the perfluorocarbon electrolyte polymer with an anion that should be transported by the cation. In addition, the structure of the anion conducting electrolyte resin is more flexible than the structure of the prior-art anion conducting electrolyte resins in which a fluorine-containing polymer and a quaternary ammonium group are connected by a covalent bond; therefore, the anion conducting electrolyte resin is able to transport an anion over a long distance and thus has high anion conducting ability. In the anion conducting electrolyte resin of the typical example, the cation has the group comprising two or more carbon atoms; therefore, the cation is able to form a longer chain molecular structure than cations which do not have that group, so that it is able to connect the perfluorocarbon electrolyte polymer with an anion that should be transported over a wider range. Also, the anion conducting electrolyte resin of the typical example has the perfluorocarbon electrolyte polymer as a part of its skeleton; therefore, the resin is dense and has high workability and durability.

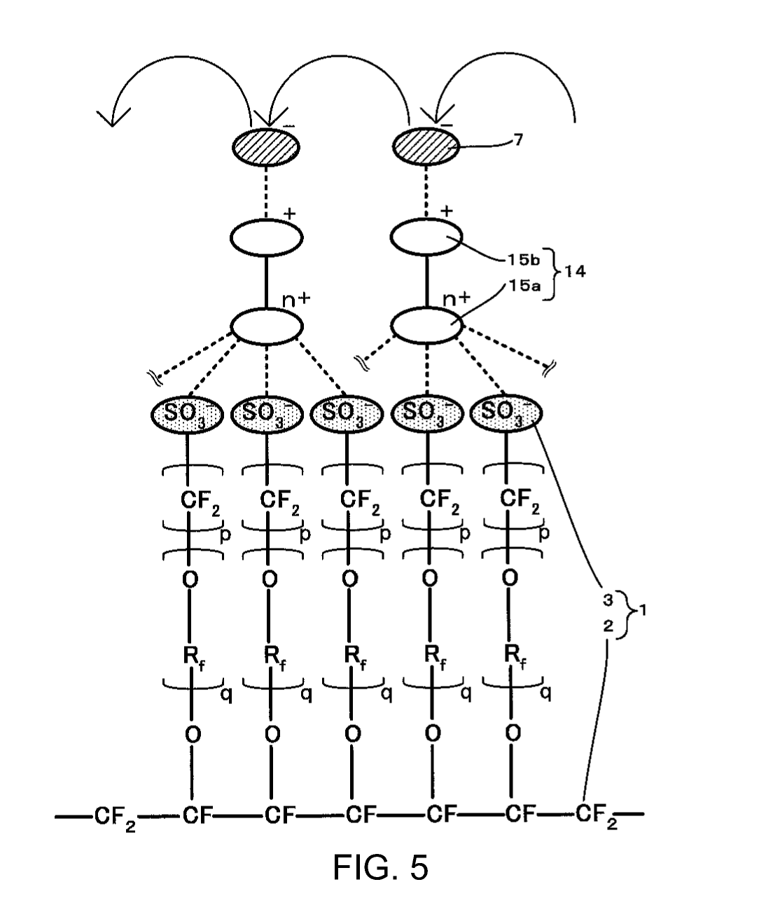

FIG. 5 is a view showing that a variation of the anion conducting electrolyte resin of the present invention transports an anion. In this figure, a solid or dotted straight line and a curved arrow line represent the same as those in FIG. 1. A double wavy line at the end of the dotted line means that the figure of an ionic bond is omitted.

The structure of the perfluorocarbon electrolyte polymer 1 is the same as the above-mentioned typical example. An ionic interaction occurs between the sulfonate group 3 of the polymer and a positively-charged group 15a which is one of positively-charged groups 15 of a modifier molecule 14 to modify the polymer 1 by the modifier molecules 14. At this time, the group 15a is a positively-charged group having an n-valent positive charge (n≧2), so that an ionic interaction is formed between the group 15a and two or more sulfonate groups 3.

Furthermore, an ionic bond is formed between the other positively charged group 15b of the modifier molecule 14 and the anion 7 to transport the anion 7. The positively-charged groups 15a and 15b of the modifier molecule 14 can be directly connected by a covalent bond or can be indirectly connected by a group such as a hydrocarbon group.

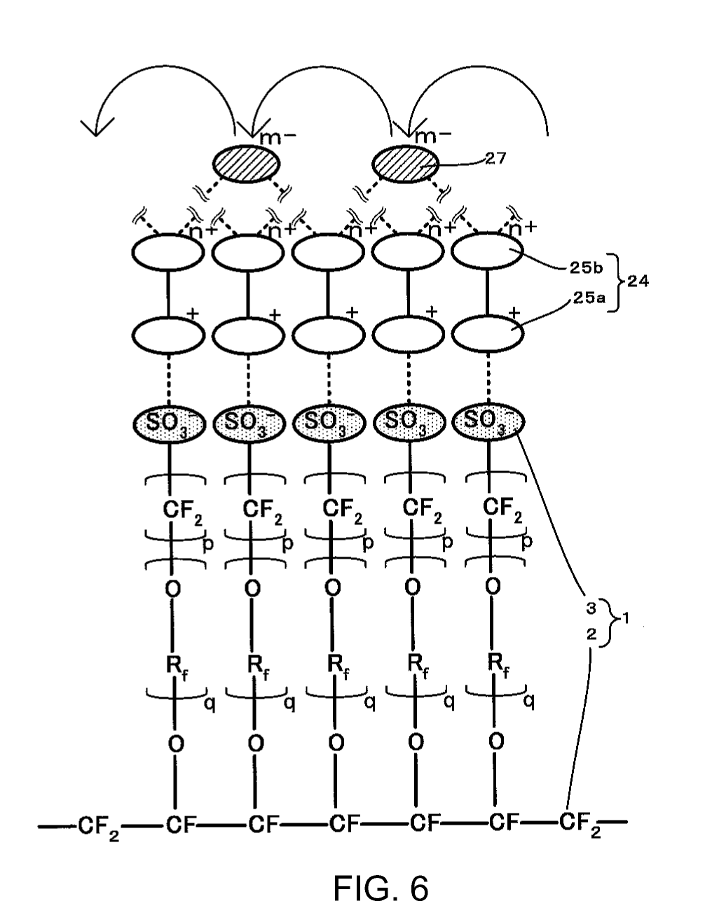

FIG. 6 is a view showing that a second variation of the anion conducting electrolyte resin of the present invention transports an anion. In this figure, a solid or dotted straight line, a curved arrow line and a double wavy line at the end of the dotted line represent the same as those in FIG. 5.

The structure of the perfluorocarbon electrolyte polymer 1 is the same as the above-mentioned typical example. An ionic bond is formed between the sulfonate group 3 of the polymer 1 and a positively-charged group 25a which is one of positively-charged groups 25 of a modifier molecule 24, on a one-to-one basis, to modify the polymer 1 by the modifier molecule 24.

A group 25b of the modifier molecule 24 is a positively-charged group having an n-valent positive charge (n≧2). An ionic interaction occurs between the group 25b and a negatively-charged anion 27 having an m-valent negative charge (m≧1) to transport the anion 27. The groups 25a and 25b of the modifier molecule 24 can be directly connected by a covalent bond or can be indirectly connected by a group such as a hydrocarbon group.

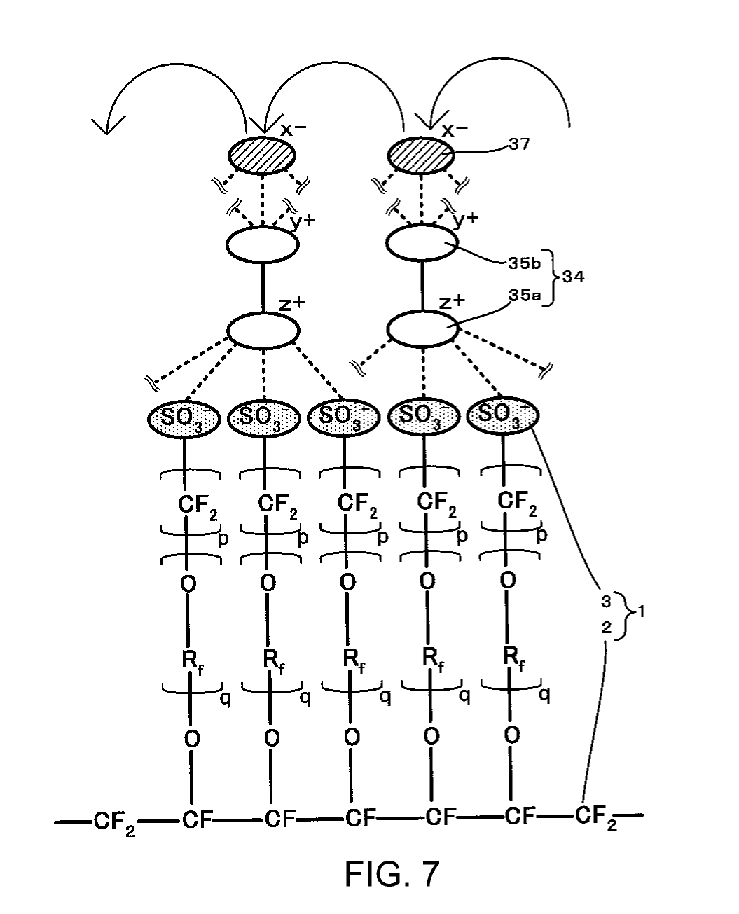

FIG. 7 is a view showing that a third variation of the anion conducting electrolyte resin of the present invention transports an anion. In this figure, a solid or dotted straight line, a curved arrow line and a double wavy line at the end of the dotted line represent the same as those in FIG. 5.

The structure of the perfluorocarbon electrolyte polymer 1 is the same as the above-mentioned typical example. An ionic interaction occurs between the sulfonate group 3 of the polymer and a positively-charged group 35a which is one of positively-charged groups 35 of a modifier molecule 34 to modify the polymer 1 by the modifier molecules 34. At this time, the group 35a is a positively-charged group having a z-valent positive charge (z≧2), so that an ionic interaction is formed between the group 35a and two or more sulfonate groups 3.

Furthermore, a group 35b of the modifier molecule 34 is a positively-charged group having y-valent positive charge (y≧2), and an ionic interaction occurs between the group 35b and an anion 37 having a x-valent negative charge (x≧1) to transport the anion 37. The groups 35a and 35b of the modifier molecule 34 can be directly connected by a covalent bond or can be indirectly connected by a group such as a hydrocarbon group.

The embodiment of the anion conducting electrolyte resin of the present invention is not limited to the above-mentioned typical examples, the above-mentioned variation, and the above-mentioned second and third variations.

The anion conducting electrolyte resin of the present invention preferably has an ion exchange capacity of 0.1 meq/g or more, more preferably 0.5 meq/g or more, most preferably 0.9 meq/g or more, so that it has sufficient anion transporting ability.

The anion conducting electrolyte resin of the present invention is preferably used for alkali fuel cells. Especially because the anion conducting electrolyte resin has the perfluorocarbon electrolyte polymer as a part of its skeleton, the resin is denser than conventional hydrocarbon-based anion conducting electrolyte resins and has excellent workability and durability. Therefore, the anion conducting electrolyte resin of the present invention is preferably used as an electrolyte resin for the cathode electrode catalyst layer of an alkali fuel cell.

In the anion conducting electrolyte resin of such a structure, an ionic interaction occurs between the sulfonate group of the perfluorocarbon electrolyte polymer and one or more of the positively-charged groups of the modifier molecule to modify the perfluorocarbon electrolyte polymer by the modifier molecules; therefore, it is able to connect the perfluorocarbon electrolyte polymer with an anion that should be transported by the modifier molecule. In addition, the structure of the anion conducting electrolyte resin of the present invention is more flexible than the structure of the prior-art anion conducting electrolyte resins in which a fluorine-containing polymer and a quaternary ammonium group are connected by a covalent bond; therefore, the anion conducting electrolyte resin of the present invention is able to transport an anion over a long distance and thus has high anion conducting ability. Also, the anion conducting electrolyte resin of the present invention has the perfluorocarbon electrolyte polymer as a part of its skeleton; therefore, the resin is dense and has high workability and durability.

The method for producing an anion conducting electrolyte resin of the present invention is a method for producing an anion conducting electrolyte resin, wherein a perfluorocarbon sulfonic acid polymer is modified by an electron-pair donating molecule comprising two or more electron-pair donating groups having an unshared electron pair each.

As the perfluorocarbon sulfonic acid polymer, there may be used any of those that were already explained in the description of the anion conducting electrolyte resin of the present invention.

The electron-pair donating groups having an unshared electron pair each are a kind of Brønsted bases. Specific examples thereof include amino groups, imidazolyl groups, pyridyl groups, phosphanyl groups, phosphanediyl groups, phosphanetriyl groups and phosphoryl groups.

The sulfonic acid group of the perfluorocarbon sulfonic acid polymer is a group that is able to give a proton to other substance, that is, a Brønsted acid. When a molecule comprising an electron-pair donating group having an unshared electron pair is added to the polymer, the reaction described by the formula (3) proceeds:

R_{f}—SO₃H+B:→R_{f}—SO₃⁻+⁺B:H (3)

wherein R_{f} refers to a perfluorocarbon structure, and B refers to a molecule comprising an electron-pair donating group having an unshared electron pair.

As just described, as a result that a so-called Brønsted acid-base reaction took place, an ionic interaction occurred between the resulting R_{f}—SO₃⁻ and ⁺B:H, thereby obtaining the above-mentioned anion conducting electrolyte resin.

Hereinafter, a typical example of the method for producing an anion conducting electrolyte resin will be explained in detail. The anion conducting electrolyte resin of the present invention can be produced by modifying a perfluorocarbon sulfonic acid polymer by an electron-pair donating molecule. When the electron-pair donating molecule is liquid at ordinary temperature, addition of the molecule is completed by immersing an assembly sheet that will be described below in the liquid for one to four hours. When the electron-pair donating molecule is gaseous at ordinary temperature, the addition is completed by spraying the gas onto the assembly sheet for one to ten hours. When the electron-pair donating molecule is solid at ordinary temperature, the addition is completed by dissolving the solid in an appropriate solvent such as pure water, an alcohol such as methanol or ethanol, an alkaline aqueous solution such as a potassium hydroxide aqueous solution, or a mixture thereof, and then immersing the assembly sheet in the solvent for one to ten hours.

Hereinafter, the second typical example of the method for producing an anion conducting electrolyte resin will be explained in detail. An electrolyte membrane comprising the above-described perfluorocarbon sulfonic acid polymer is modified by the electron-pair donating molecules. The modifying method is the same as the above typical example of the method for producing an anion conducting electrolyte resin. After the modification, an excess of the electron-pair donating molecules or solvent is removed by drying, thereby achieving the anion conducting electrolyte resin of the present invention.

Hereinafter, a typical example of the method for producing an electrode catalyst layer with the anion conducting electrolyte resin, will be described in detail.

First, a catalyst sheet is taken. As the catalyst sheet, usually, there may be used one in which a catalyst is deposited on a gas diffusion layer sheet, the catalyst comprising a catalytic component supported by conductive particles.

The catalytic component is not particularly limited as long as it has a catalytic activity for an oxidization reaction by the fuel of a fuel electrode or a reduction reaction by the oxidant of an oxidant electrode. As the catalytic component, there may be used one that is generally used for solid polymer fuel cells. For example, there may be used platinum or an alloy of platinum and a metal such as ruthenium, iron, nickel, manganese, cobalt and copper.

As the conductive particles (catalyst support), for example, there may be used a conductive carbon material such as carbon particles (e.g., carbon black) and carbon fiber, and a metal material such as metal particles and metal fiber. The conductive material also acts as a conductive material that imparts conductivity to the catalyst.

As the gas diffusion layer sheet, there may be mentioned one which has gas diffusivity that allows an efficient gas supply to the catalyst, conductivity, and strength that is required for the material comprising the gas diffusion layer to have. As the gas diffusion layer sheet, for example, there may be mentioned a porous carbonaceous material such as carbon paper, carbon cloth and carbon felt, titanium, aluminum, copper, nickel, a nickel-chromium alloy, copper and copper alloys, and a conductive porous material such as a metal mesh or porous metal material comprising a metal such as silver, an aluminum alloy, a zinc alloy, a lead alloy, titanium, niobium, tantalum, iron, stainless-steel, gold or platinum.

Next, the catalyst sheet is impregnated with the perfluorocarbon sulfonic acid polymer solution. The solvent is removed therefrom, thereby forming a catalyst-perfluorocarbon sulfonic acid polymer assembly.

The perfluorocarbon sulfonic acid polymer is modified by electron-pair donating molecules in the same manner as the above-described typical example of the method for producing an anion conducting electrolyte resin. The resulting assembly sheet which completed the modification of the polymer by the electron-pair donating molecules, is dried to remove an excess of the electron-pair donating molecules or solvent, thereby achieving an electrode catalyst layer comprising the anion conducting electrolyte resin of the present invention.

Preferably, the electron-pair donating molecule is an amine molecule in which two or more amino groups are connected to a group comprising two or more carbon atoms. The reason is as follows: the amine molecule shows excellent unshared electron pair donating ability, so that it is able to obtain the anion conducting electrolyte resin of the present invention just by adding the amine molecule to the perfluorocarbon sulfonic acid polymer.

In an embodiment of the method for producing an anion conducting electrolyte resin of the present invention, it is possible that the amino groups are a primary or secondary amino group each.

Preferably, the group comprising two or more carbon atoms of the amine molecule is a hydrocarbon group. The reason is as follows: the amine molecule can be designed into various types of amine molecules by changing the carbon chain length of the hydrocarbon group and the bonding configuration of the carbon chain of the hydrocarbon group; therefore, the type of the amine molecule can be selected from various possible types, depending on the intended use.

Preferably, the hydrocarbon group has 2 to 4 carbon atoms. This is because it is possible to produce an anion conducting electrolyte resin in which the cation has the hydrocarbon group which has a length that is appropriate for anion giving and receiving.

Due to the above reasons, those that are preferred as the amine molecule include diaminoalkanes such as diaminomethane, 1,2-diaminoethane, 1,3-diaminopropane, 1,4-diaminobutane, 1,5-diaminopentane, 1,6-diaminohexane, 1,7-diaminoheptane, 1,8-diaminooctane, 1,9-diaminononane and 1,10-diaminodecane, 3-(methylamino)propylamine, 3,3-bis(methylamino)propylamine, 3,3-bis(ethylamino)propylamine, 3,3-bis(butylamino)propylamine, N-(2-aminoethyl)ethanolamine, polyamine compounds having an aromatic ring, such as m-phenylenediamine, and polyethyleneimines such as diethylenetriamine, triethylenetetramine, tetraethyleneheptamine and hexamethylenetetramine.

Examples of the amine molecule for producing “the cation which has a structure in which two or more groups are connected to at least one ammonium group, each of the groups being the group comprising two or more carbon atoms, to which one or more ammonium groups are connected” (see the above description of the anion conducting electrolyte resin) include polyethyleneimines such as diethylenetriamine, triethylenetetramine, tetraethyleneheptamine and hexamethylenetetramine.

The method for producing an anion conducting electrolyte resin of such a structure provides the anion conducting electrolyte resin of the present invention by adding the electron-pair donating molecules to the perfluorocarbon sulfonic acid polymer.

### EXAMPLES

### 1. Production of Anion Conducting Electrolyte Resin and Electrode Catalyst Layer Comprising the Same

### Example 1

A carbon paper on which platinum-supported carbon is deposited (manufactured by E-TEC (an American company), supported Pt amount: 1 mg/cm²) was used as the cathode catalyst. A 5% by mass Nafion (trade name) solution, which is a kind of perfluorocarbon sulfonic acid polymer, was added to the cathode catalyst sheet, followed by removal of the solvent, thereby forming a cathode catalyst-perfluorocarbon sulfonic acid polymer assembly. The assembly sheet was immersed in ethylenediamine (a kind of electron-pair donating molecule) for two hours and dried at room temperature to synthesize an ethylenediamine-modified perfluorocarbon sulfonic acid polymer which covers the platinum-supported carbon on the carbon paper. This cathode catalyst sheet was attached to an anion exchange membrane (A-006 manufactured by Tokuyama Corp., thickness: 28 μm) to achieve an electrode catalyst layer comprising the ethylenediamine-modified perfluorocarbon sulfonic acid polymer.

### Example 2

A Nafion (trade name) 112 membrane, which is a kind of perfluorocarbon sulfonic acid polymer electrolyte membrane, was immersed in ethylenediamine (a kind of electron-pair donating molecule) and dried at room temperature to produce an ethylenediamine-modified perfluorocarbon sulfonic acid polymer electrolyte resin.

### Example 3

A carbon paper on which platinum-supported carbon is deposited (manufactured by E-TEC (an American company), supported Pt amount: 1 mg/cm²) was used as the cathode catalyst. A 5% by mass Nafion (trade name) solution, which is a kind of perfluorocarbon sulfonic acid polymer, was added to the cathode catalyst sheet, followed by removal of the solvent, thereby forming a cathode catalyst-perfluorocarbon sulfonic acid polymer assembly. The assembly sheet was immersed in diethylenetriamine (a kind of electron-pair donating molecule) for two hours and dried at room temperature to synthesize a diethylenetriamine-modified perfluorocarbon sulfonic acid polymer which covers the platinum-supported carbon on the carbon paper. This cathode catalyst sheet was attached to an anion exchange membrane (A-006 manufactured by Tokuyama Corp., thickness: 28 μm) to achieve an electrode catalyst layer comprising the diethylenetriamine-modified perfluorocarbon sulfonic acid polymer.

### Example 4

A Nafion (trade name) 112 membrane, which is a kind of perfluorocarbon sulfonic acid polymer electrolyte membrane, was immersed in diethylenetriamine (a kind of electron-pair donating molecule) and dried at room temperature to produce a diethylenetriamine-modified perfluorocarbon sulfonic acid polymer electrolyte resin.

### Comparative Example

The process of Comparative Example is the same as that of Example 1 until the formation of a cathode catalyst-perfluorocarbon sulfonic acid polymer assembly. This assembly sheet was immersed in a 1 mol/L potassium hydroxide aqueous solution, washed with ultrapure water and then dried to synthesize a perfluorocarbon sulfonic acid polymer which is modified by the potassium and covers the platinum-supported carbon on the carbon paper. This cathode catalyst sheet was attached to an anion exchange membrane in the same manner as Example 1.

### 2. Electrochemical Measurement

### 2-1. Measurement of Oxygen Reduction Properties

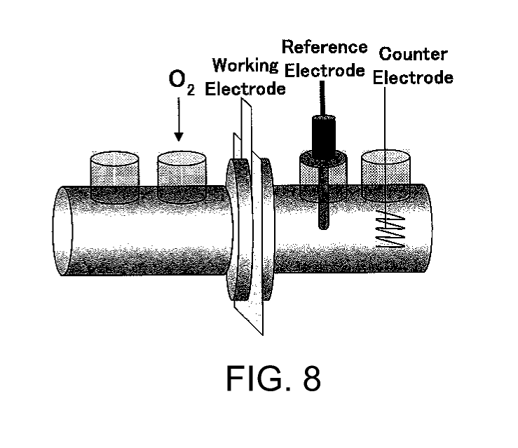

Oxygen reduction reaction at the cathode was measured in detail for an electrode surface area of 3.8 cm² by means of a two-compartment cell. FIG. 8 is a schematic view showing the two-compartment cell. Pure oxygen is supplied to the cathode room on the left side of the figure. The anode room on the right side of the figure is filled with a 1 mol/L potassium hydroxide aqueous solution, and a platinum wire and a silver/silver chloride electrode are used as the counter electrode and the reference electrode, respectively. Using this two-compartment cell, the performance of the electrode catalyst layers produced in Example 1, Example 3 and Comparative Example were evaluated by a quasi-steady-state polarization method and a potential sweep method (as the working electrode, the electrode catalyst layer was sandwiched between the two compartments of the cell and measured).

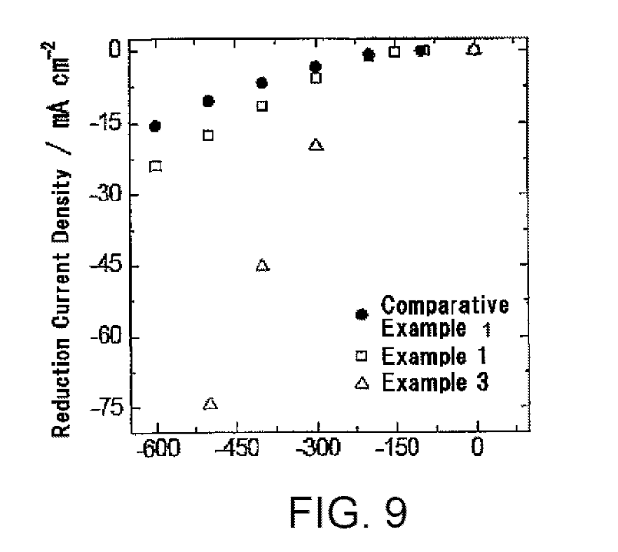

FIG. 9 shows the result of measuring oxygen reduction reaction by a quasi-steady-state polarization method. The oxygen reduction current value of the electrode catalyst layer comprising the ethylenediamine-modified perfluorocarbon sulfonic acid polymer, which is plotted with white squares (Example 1), and the oxygen reduction current value of the electrode catalyst layer comprising the diethylenetriamine-modified perfluorocarbon sulfonic acid polymer, which is plotted with white triangles (Example 3), are both higher than the oxygen reduction current value of the electrode catalyst layer comprising the potassium-modified perfluorocarbon sulfonic acid polymer, which is plotted with black circles (Comparative Example).

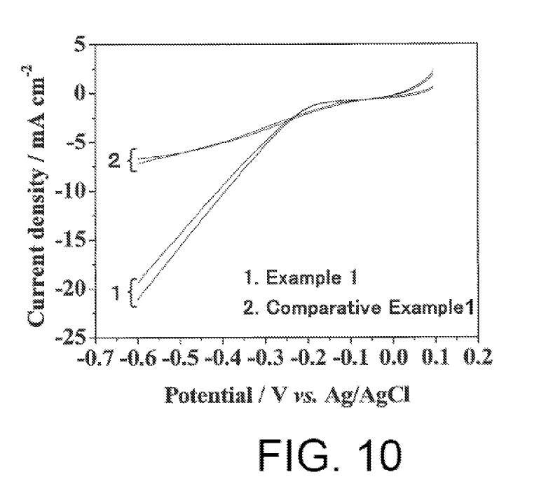

FIG. 10 shows potential curves of oxygen reduction reaction measured by a potential sweep method. The oxygen reduction current value of the electrode catalyst layer comprising the ethylenediamine-modified perfluorocarbon sulfonic acid polymer, which is represented by curve 1 (Example 1), is higher than the oxygen reduction current value of the electrode catalyst layer comprising the potassium-modified perfluorocarbon sulfonic acid polymer, which is represented by curve 2 (Comparative Example).

### 2-2. Measurement of Anionic Transport Number

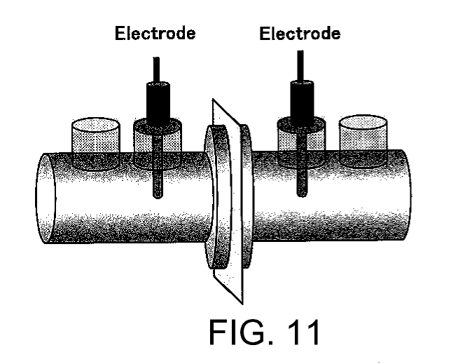

The anionic transport number of the ethylenediamine-modified perfluorocarbon sulfonic acid polymer electrolyte resin produced in Example 2 and that of the diethylenetriamine-modified perfluorocarbon sulfonic acid polymer electrolyte resin produced in Example 4, were electrochemically measured by means of a two-compartment cell and calculated. FIG. 11 is a schematic view of the two-component cell. Both of the two compartments are filled with a potassium hydroxide aqueous solution, and the concentration of the aqueous solution varies with each measurement. A silver/silver chloride electrode was used as the electrode of each compartment. The electrolyte membrane of Example 2 was sandwiched between the two compartments of the cell for measurement.

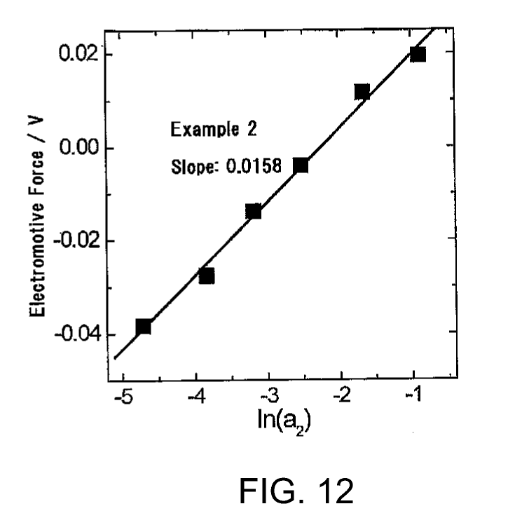

FIG. 12 shows an experimental result data showing the relationship between membrane potential Eₘ and ln(a₂) of the ethylenediamine-modified perfluorocarbon sulfonic acid polymer electrolyte resin produced in Example 2, ln(a₂) being obtained from activity a₂ of the potassium hydroxide aqueous solution in one of the two compartments of the cell. Anionic transport number t_ can be obtained by using the below-mentioned formula which represents the membrane potential (formula (4)). The straight line plotted through the data points shown in FIG. 12 has a slope of 0.0158; therefore, the anionic transport number t_ of the ethylenediamine-modified perfluorocarbon sulfonic acid polymer electrolyte resin produced in Example 2, was calculated to be 0.814.

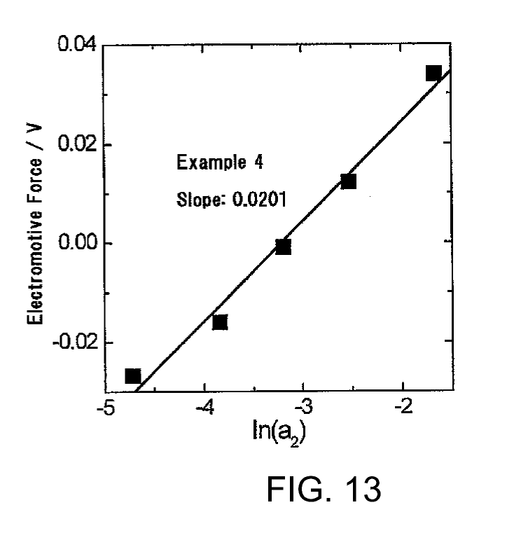

FIG. 13 shows an experimental result data showing the relationship between membrane potential Eₘ and ln(a₂) of the diethylenetriamine-modified perfluorocarbon sulfonic acid polymer electrolyte resin produced in Example 4, ln(a₂) being obtained from activity a₂ of the potassium hydroxide aqueous solution in one of the two compartments of the cell. Anionic transport number t_ can be obtained by using the below-mentioned formula which represents the membrane potential (formula (4)). The straight line plotted through the data points shown in FIG. 13 has a slope of 0.0201; therefore, the anionic transport number t_ of the diethylenetriamine-modified perfluorocarbon sulfonic acid polymer electrolyte resin produced in Example 4, was calculated to be 0.891.

$$\begin{matrix}[ Mathematical formula 1 ] & \\ {E}_{m} = - ( 1 - 2 {t}_{-} ) \frac{RT}{F} ln ( \frac{{a}_{2}}{{a}_{1}} ) & ( 4 )\end{matrix}$$

wherein Eₘ represents membrane potential; t_ represents anionic transport number; R represents gas constant; T represents temperature; F represents Faraday constant; and a₁ and a₂ represent the activity of the potassium hydroxide aqueous solution each.

### 3. Conclusion

The anion conducting electrolyte resin of the present invention and the electrode catalyst layer comprising the same were obtained in Examples by adding ethylenediamine or diethylenetriamine, each of which is a kind of electron-pair donating molecule, to Nafion, which is a kind of perfluorocarbon sulfonic acid polymer. Compared to the electrode catalyst layer which was obtained in Comparative Example and to which no electron-pair donating molecule was added, the electrode catalyst layers produced in Examples were found to have a higher oxygen reduction current value by any of the quasi-steady-state polarization method and the potential sweep method. Furthermore, the anionic transport number t_ of the ethylenediamine-modified perfluorocarbon sulfonic acid polymer electrolyte resin produced in Example 2 was calculated to be 0.814, while the anionic transport number t_ of the diethylenetriamine-modified perfluorocarbon sulfonic acid polymer electrolyte resin produced in Example 4 was calculated to be 0.891. Therefore, the anion conducting electrolyte resin of the present invention was found to show extremely high anion conducting ability.

### REFERENCE SIGNS LIST

1. Perfluorocarbon electrolyte polymer
2. Perfluorocarbon skeleton
3. Sulfonate group
4. Modifier molecule
4a, 4b and 4c. Cation
5a and 5b. Positively-charged group
5aa, 5ba, 5bb, 5ac and 5bc. Ammonium group
5ab. Secondary ammonium group
7. Anion
14. Modifier molecule
15a and 15b. Positively-charged group
24. Modifier molecule
25a and 25b. Positively-charged group
27. Anion
34. Modifier molecule
35a and 35b. Positively-charged group
37. Anion

1. An anion conducting electrolyte resin comprising a perfluorocarbon electrolyte polymer in which the whole or part of the polymer has a sulfonate group (—SO₃⁻), and a modifier molecule comprising two or more positively-charged groups,
wherein an ionic interaction occurs between the sulfonate group of the perfluorocarbon electrolyte polymer and one or more of the positively-charged groups of the modifier molecule to modify the perfluorocarbon electrolyte polymer by the modifier molecules, and
wherein an ionic interaction occurs between the rest of the positively-charged groups of the modifier molecule and a hydroxide ion (OH⁻).

2. The anion conducting electrolyte resin according to claim 1,
wherein the modifier molecule is a cation in which two or more ammonium groups are connected to a group comprising two or more carbon atoms;
wherein an ionic bond is formed between the sulfonate group of the perfluorocarbon electrolyte polymer and one or more of the ammonium groups of the cation to connect the perfluorocarbon electrolyte polymer with the cations; and
wherein an ionic bond is formed between the rest of the ammonium groups of the cation and the hydroxide ion.

3. The anion conducting electrolyte resin according to claim 2,
wherein the cation has a structure in which two or more groups are connected to at least one first ammonium group, each of the groups being the group comprising two or more carbon atoms, to which one or more second ammonium groups are connected.

4. The anion conducting electrolyte resin according to claim 3, wherein the first ammonium group is a secondary ammonium group.

5. The anion conducting electrolyte resin according to claim 2, wherein the group comprising two or more carbon atoms of the cation is a hydrocarbon group.

6. The anion conducting electrolyte resin according to claim 5, wherein the hydrocarbon group has 2 to 4 carbon atoms.

7. The anion conducting electrolyte resin according to claim 1, having an ion exchange capacity of 0.5 meq/g or more.

8. The anion conducting electrolyte resin according to claim 1, which is used for alkali fuel cells.

9. The anion conducting electrolyte resin according to claim 1, which is used as an electrolyte resin for the cathode electrode catalyst layer of an alkali fuel cell.

10. A method for producing an anion conducting electrolyte resin,
wherein an electron-pair donating molecule comprising two or more electron-pair donating groups having an unshared electron pair each, is added to a perfluorocarbon sulfonic acid polymer so that the perfluorocarbon sulfonic acid polymer is modified by the electron-pair donating molecules by an ionic interaction between a sulfonate group (—SO₃⁻) which is derived from a sulfonic acid group (—SO₃H) of the perfluorocarbon sulfonic acid polymer and a cation which is derived from a part of the electron-pair donating groups of the electron-pair donating molecule, thereby leaving the electron-pair donating group having no ionic interaction with the sulfonate group on the electron-pair donating molecule.

11. The method for producing an anion conducting electrolyte resin according to claim 10, wherein the electron-pair donating molecule is an amine molecule in which two or more amino groups are connected to a group comprising two or more carbon atoms.

12. The method for producing an anion conducting electrolyte resin according to claim 11, wherein the amino groups are a primary or secondary amino group each.

13. The method for producing an anion conducting electrolyte resin according to claim 11, wherein the group comprising two or more carbon atoms of the amine molecule is a hydrocarbon group.

14. The method for producing an anion conducting electrolyte resin according to claim 13, wherein the hydrocarbon group has 2 to 4 carbon atoms.
